(19) United States
(12) Patent Application Publication
(10) Pub. No.: US 2021/0033850 A1
(43) Pub. Date: Feb. 4, 2021

(54) OPTICAL FIBER SCANNER, OPTICAL FIBER SCANNING DEVICE AND OPTICAL FIBER SCANNING APPARATUS

(71) Applicant: CHENGDU IDEALSEE TECHNOLOGY CO., LTD., Chengdu, Sichuan (CN)

(72) Inventor: Changcheng Yao, Chengdu, Sichuan (CN)

(21) Appl. No.: 16/968,265

(22) PCT Filed: Jan. 25, 2019
(86) PCT No.: PCT/CN2019/073137

§ 371 Date: Aug. 7, 2020

(30) Foreign Application Priority Data
Feb. 9, 2018 (CN) 201810136357.0
Feb. 9, 2018 (CN) 201820236193.4

(51) Int. Cl. G02B 26/10; G06K 7/10

(52) U.S. Cl. CPC G02B 26/10; G06K 7/10871

(57) ABSTRACT

Disclosed are an optical fiber scanner, an optical fiber scanning device and an optical fiber scanning apparatus. The optical fiber scanner includes a slow-axis driving unit, a connector and N fast-axis driving units. The connector has a slow-axis connecting structure and N fast-axis connecting structures. The slow-axis driving unit is connected to the N fast-axis driving units by means of the connector, N being an integer greater than or equal to 2. One slow-axis driving unit is connected to N fast-axis driving units by means of a connector, that is, one slow-axis driving unit can drive N fast-axis driving units simultaneously. In this way, the N fast-axis driving units can move synchronously in the vibration direction of the slow-axis driving unit, thereby achieving the technical effect of outputting high quality images.

### CROSS-REFERENCE TO RELATED APPLICATIONS

This application claims the priority of Chinese patent application. CN201810136357.0, entitled “Optical fiber scanner, optical fiber scanning device and optical fiber scanning apparatus” and filed on Feb. 9, 2018 as well as Chinese patent application CN201820236193.4, entitled “Optical fiber scanner, optical fiber scanning device and optical fiber scanning apparatus” and filed on Feb. 9, 2018, the entirety of which is incorporated herein by reference.

### FIELD OF THE INVENTION

The present disclosure relates to the field of optical fiber scanning, and in particular, to an optical fiber scanner, an optical fiber scanning device and an optical fiber scanning apparatus.

### BACKGROUND OF THE INVENTION

Optical fiber scanners can scan according to trajectories pre-designed by designers so as to output images, thereby replacing traditional LCD (Liquid Crystal Display), LCOS (Liquid Crystal on Silicon) and OLED (Organic Light-Emitting Diode) image sources, etc. In addition, fiber optical scanners can also be integrated into devices, such as HMDs (Head Mount Displays), micro-projectors and vehicle HUDs (Head Up Displays). Besides, optical fiber scanners can also be used in devices such as medical endoscopes and scanning tunneling microscopes, and have a wide range of applications.

As the requirements for image quality are getting higher and higher and the requirements for parameters such as image size and resolution are getting higher and higher, optical fiber scanners that can drive only one optical fiber can no longer meet the requirements.

### SUMMARY OF THE INVENTION

Embodiments of the present disclosure provide an optical fiber scanner, an optical fiber scanning device and an optical fiber scanning apparatus, which are used for outputting high quality images.

In order to achieve the above object of the present disclosure, a first aspect of the embodiments of the present disclosure provides an optical fiber scanner, including a slow-axis driving unit, a connector, and N fast-axis driving units. The connector has a slow-axis connecting structure for connecting the slow-axis driving unit, and N fast-axis connecting structures for connecting the N fast-axis driving units, and the slow-axis driving unit is connected to the N fast-axis driving units by means of the connector, N being an integer greater than or equal to 2.

Alternatively, the fast-axis driving units each have a sheet-like shape; and the N fast-axis driving units are fixed to the connector in parallel, or the N fast-axis driving units are fixed radially to the connector.

Alternatively, one or more optical fibers are fixed to each of the fast-axis driving units.

A second aspect of the embodiments of the present disclosure provides an optical fiber scanning device, including a base and at least one optical fiber scanner according to the first aspect.

Alternatively, a surface of the base that carries the optical fiber scanner is a flat surface or a curved surface.

Alternatively, provided is a plurality of optical fiber scanners, the plurality of optical fiber scanners forming a j*k array, j and k being positive integers.

Alternatively, provided is a plurality of optical fiber scanners, the plurality of optical fiber scanners being arranged radially.

A third aspect of the embodiments of the present disclosure provides an optical fiber scanning projection apparatus, including the optical fiber scanning device according to the second aspect and a plurality of laser light sources. Optical fibers in the optical fiber scanning device are in one-to-one correspondence with the laser light sources.

Alternatively, the laser light sources are solid lasers, gas lasers or optical fiber lasers.

Alternatively, the laser light sources include a red laser, a green laser, a blue laser, and a light combining unit.

One or more technical solutions in the embodiments of the present disclosure have at least the following technical effects or advantages.

One slow-axis driving unit is connected to N fast-axis driving units by means of a connector, that is, one slow-axis driving unit can drive N fast-axis driving units simultaneously. In this way, the N fast-axis driving units can move synchronously in the vibration direction of the slow-axis driving unit, thereby achieving the technical effect of outputting high quality images. In addition, this can not only achieve large-size and high-resolution display by stitching N images of the N fast-axis driving units, while ensuring synchronous display without delay between the images emitted by the respective fast-axis driving units, but also helps to decrease the vibration frequency of the slow-axis driving unit so that the slow-axis driving unit with a relatively small size can achieve a relatively large scan range, and the driving method is simple, being conducive to the miniaturization of optical fiber scanners, thereby expanding application scenarios of optical fiber scanners.

### BRIEF DESCRIPTION OF THE DRAWINGS

FIG. 1 is a schematic diagram showing a structure of an optical fiber scanner provided by an embodiment of the present disclosure;

FIG. 2A is a schematic diagram showing a structure when an optical fiber scanner is provided with two fast-axis driving units;

FIG. 2B is a schematic diagram of a first stitched image provided by an embodiment of the present disclosure;

FIG. 2C is a schematic diagram showing that two fast-axis driving units are fixed radially to a connector in an optical fiber scanner provided by an embodiment of the present disclosure;

FIGS. 2D and 2E are schematic diagrams each showing that two optical fibers are provided on each fast-axis driving unit in an optical fiber scanner provided by an embodiment of the present disclosure;

FIG. 2F is a schematic diagram of a second stitched image provided by an embodiment of the present disclosure;

FIG. 3A and 3B are schematic diagrams each showing a structure when an optical fiber scanner is provided with three fast-axis driving units;

FIG. 3C is a schematic diagram of a third stitched image provided by an embodiment of the present disclosure;

FIG. 4A and 4B are schematic diagrams each showing arrangement of a plurality of optical fiber scanners in an optical fiber scanning device with a base having a curved surface, according to an embodiment of the present disclosure;

FIG. 4C is a schematic diagram showing arrangement of a plurality of optical fiber scanners in an optical fiber scanning device with a base having a flat surface, according to an embodiment of the present disclosure;

FIG. 4D is a diagram of a comparison between two optical fiber scanners arranged in parallel and two optical fiber scanners arranged radially; and

FIG. 5 is a schematic diagram showing a structure of a laser provided by an embodiment of the present disclosure.

### DETAILED DESCRIPTION OF THE EMBODIMENTS

Technical solutions in embodiments of the present disclosure will be clearly and completely described below in conjunction with drawings in the embodiments of the present disclosure. Obviously, the described embodiments are only a part of the embodiments of the present disclosure, rather than all the embodiments of the present disclosure. Based on the embodiments of the present disclosure, all other embodiments obtained by those of ordinary skill in the art without inventive efforts shall fall within the protection scope of the present disclosure.

The embodiments of the present disclosure provide an optical fiber scanner, an optical fiber scanning device and an optical fiber scanning apparatus, which are used for outputting images with large size, high resolution and high frame rate.

A first aspect of the embodiments of the present disclosure provides an optical fiber scanner. Referring to FIG. 1, FIG. 1 is a schematic diagram showing a structure of an optical fiber scanner provided by an embodiment of the present disclosure. As shown in FIG. 1, the optical fiber scanner includes a slow-axis driving unit 101, a connector 102, and N fast-axis driving units 103. Here, N is an integer greater than or equal to 2. Correspondingly, the connector 102 has a slow-axis connecting structure 1021 and N fast-axis connecting structures 1022. The N fast-axis connecting structures 1022 are in one-to-one correspondence with the N fast-axis driving units 103. In this way, the slow-axis driving unit 101 can be connected to the slow-axis connecting structure 1021, and each fast-axis driving units 103 of the N fast-axis driving units 103 can be connected to a corresponding fast-axis connecting structure 1022. In other words, the slow-axis driving unit 101 is connected to the N fast-axis driving units 103 through the connector 102.

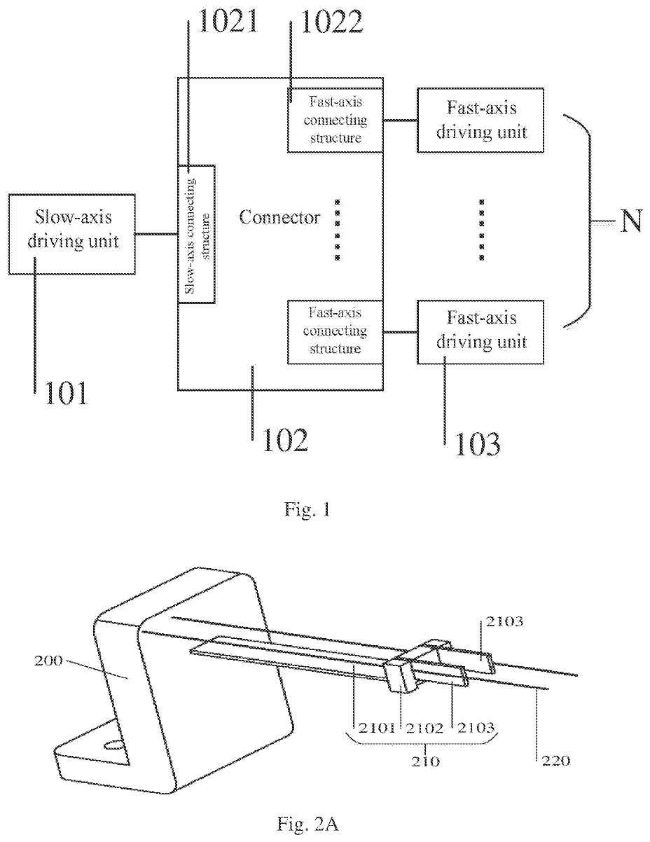

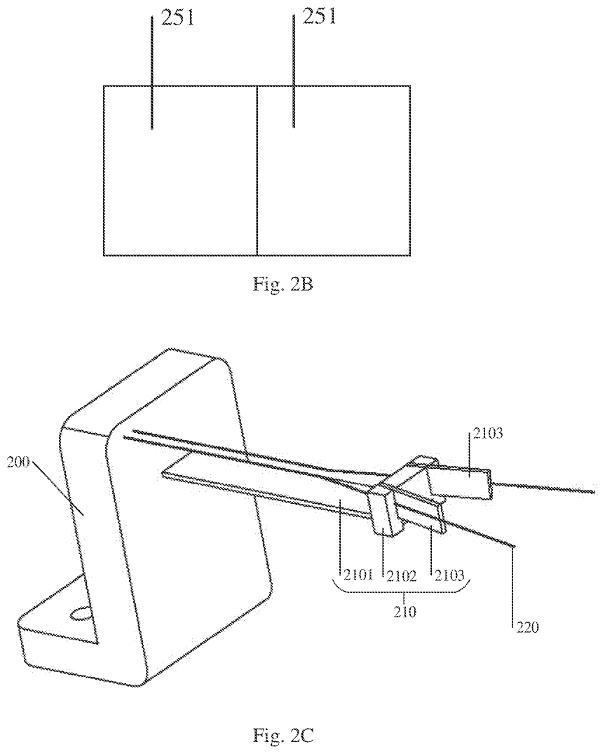

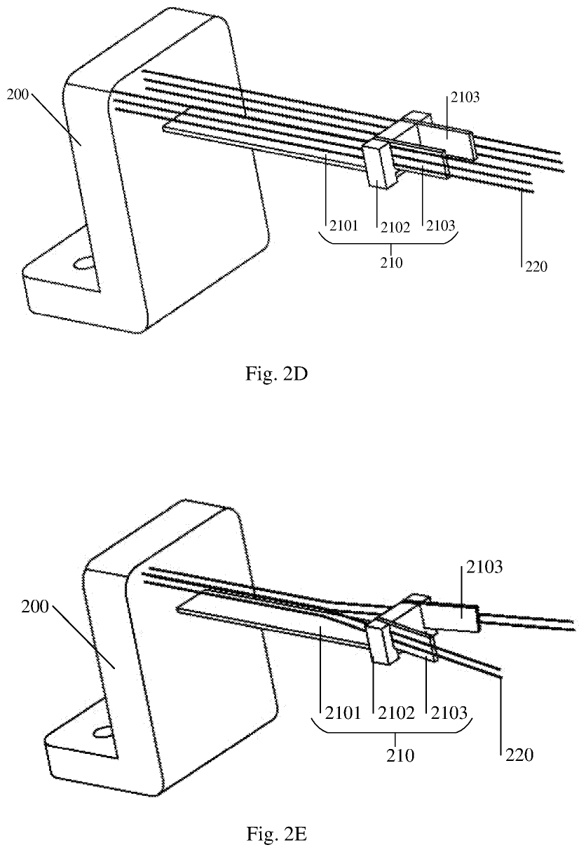

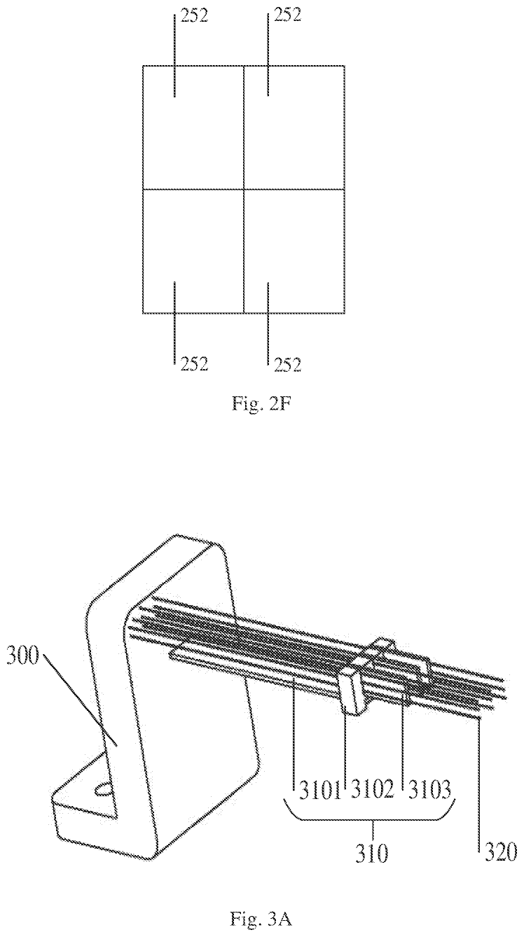

In FIGS. 2A-2E described below, a base 200 is used for carrying an optical fiber scanner 210, and the optical fiber scanner 210 is provided with optical fibers 220. It should be noted that the optical fibers 220 are not all labeled.

Referring to FIG. 2A, FIG. 2A is a schematic diagram showing a structure when an optical fiber scanner is provided with two fast-axis driving units. As shown in FIG. 2A, a slow-axis driving unit 2101 is connected to a slow-axis connecting structure (not shown) on a connector 2102, and two-fast-axis driving units 2103 are respectively connected to two fast-axis connecting structures (not shown) on the connector 2102. In this way, the slow-axis driving unit 2101 is connected to the two fast-axis driving units 2103 through the connector 2102. Therefore, one slow-axis driving unit 2101 can drive two fast-axis driving units 2103 simultaneously, and the two fast-axis driving units 2103 can drive their own optical fibers for scanning. With continued reference to FIG. 2B, FIG. 2B is a schematic diagram of a first stitched image provided by an embodiment of the present disclosure. As shown in FIG. 213, two sub-images 251 emitted by the two fast-axis driving units 2103 are stitched together to form an image with a larger size. Compared with an optical fiber scanner that drives one fiber, the optical fiber scanner shown in FIG. 2A outputs an image with a doubled size and doubled resolution, achieving the purpose of outputting higher quality images, and this will not be repeated here.

Of course, it should be noted that as a distance between an optical fiber scanner and an imaging screen changes, a distance and angle between various fast-axis driving units need to be changed accordingly, or a scanning trajectory of each optical fiber scanner needs to be adjusted accordingly. Those skilled in the art can make adjustments according to an actual situation, otherwise it will cause defects such as image overlap or stitching gaps in a stitched image, which will affect the image quality.

As can be seen, one slow-axis driving unit 101 is connected to N fast-axis driving units 103 through the connector 102, that is, one slow-axis driving unit 101 can drive N fast-axis driving units 103 simultaneously. In this way, the N fast-axis driving units can move synchronously in the vibration direction of the slow-axis driving unit, thereby achieving the technical effect of outputting high quality images. In addition, this can not only realize large-size and high-resolution display by stitching N images of the N fast-axis driving units 103, while ensuring synchronous display without delay between the images emitted by the respective fast-axis driving units 103, but also helps to reduce the vibration frequency of the slow-axis driving unit 101 so that the slow-axis driving unit 101 with a relatively small size can achieve a relatively large scan range, and the driving method is simple, being conducive to the miniaturization of optical fiber scanners, thereby expanding application scenarios of optical fiber scanners.

In the specific implementation process, the slow-axis driving unit 101 and the fast-axis driving units 103 in the optical fiber scanner are generally made of piezoelectric ceramics, and they generally have a sheet-like shape. The N fast-axis driving units may be fixed to the connector in parallel, or may be fixed radially to the connector. With continued reference to FIG. 2A, FIG. 2A shows a case where two fast-axis driving units are fixed to a connector in parallel in an optical fiber scanner. With continued reference to FIG. 2C, FIG. 2C is a schematic diagram showing that two fast-axis driving units are fixed radially to a connector in an optical fiber scanner provided in an embodiment of the present disclosure. Of course, it should be noted that a distance or angle between the fast-axis driving units may be set according to actual situations so as to meet requirements of actual situations, and this is not limited here.

In the specific implementation process, one or more optical fibers may be fixed to each fast-axis driving unit. With continued reference to FIGS. 2A and 2B, FIGS. 2A and 2B are schematic diagrams each showing that one optical fiber is fixed to each fast-axis driving unit in an optical fiber scanner. With continued reference to FIGS. 2D and 2E, FIGS. 2D and FIG. 2E are schematic diagrams each showing that two optical fibers are fixed to each fast-axis driving unit in an optical fiber scanner provided by an embodiment of the present disclosure. FIG. 2D shows a case where two fast-axis driving units are fixed to a connector in parallel in an optical fiber scanner, and FIG. 2E shows a case where two fast-axis driving units are fixed radially to a connector in an optical fiber scanner. With continued reference to FIG. 2F, FIG. 2F is a schematic diagram of a second stitched image provided by an embodiment of the present disclosure. As shown in FIG. 2F, four sub-images 252 emitted by two fast-axis driving units in the optical fiber scanner are stitched together, and this will not be repeated here.

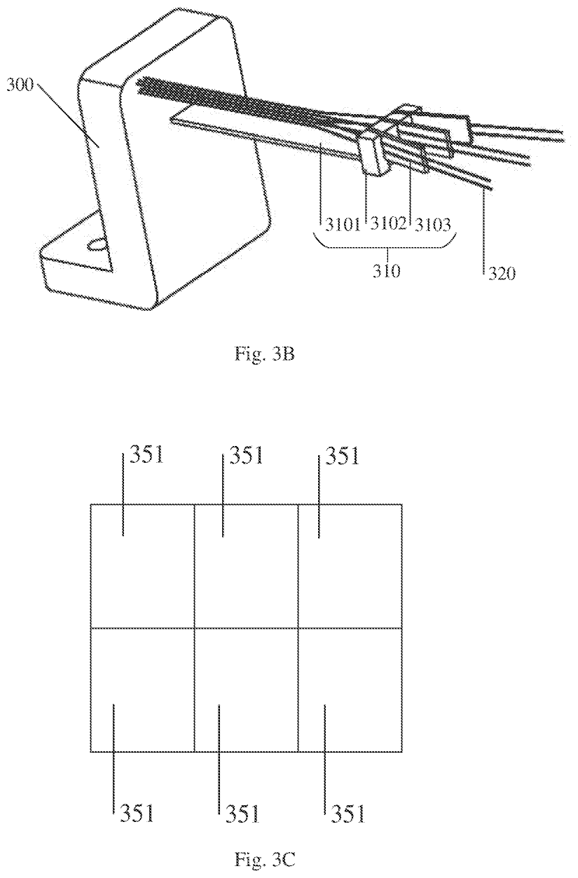

In FIGS. 3A-3C described below, a base 300 is used for carrying an optical fiber scanner 310. The optical fiber scanner 310 includes a slow-axis driving unit 3101, a connector 3102, and fast-axis driving units 3103. The optical fiber scanner 310 is provided with optical fibers 320. It should be noted that the optical fibers 320 are not all labeled.

With continued reference to FIGS. 3A and 3B, FIGS. 3A and 3B are schematic diagrams each showing a structure when an optical fiber scanner is provided with three fast-axis driving units. FIG. 3A shows a case where three fast-axis driving units are fixed to a connector in parallel in an optical fiber scanner, and FIG. 3B shows a case where three fast-axis driving units are fixed radially to a connector in an optical fiber scanner. With continued reference to FIG. 3C, FIG. 3C is a schematic diagram of a third stitched image provided by an embodiment of the present disclosure. As shown in FIG. 3C, each fast-axis driving unit is provided with two optical fibers. In this way, six sub-images 351 emitted by three fast-axis driving units in the optical fiber scanner are stitched together, and this will not be repeated here.

Through the introduction of this embodiment, those skilled in the art can infer by analogy the specific structure when four or more fast-axis driving units are provided in the optical fiber scanner, and this will not be repeated here.

Based on the same inventive concept, a second aspect of the embodiments of the present disclosure further provides an optical fiber scanning device. The optical fiber scanning device includes a base and the optical fiber scanner described in the first aspect. The optical fiber scanner has been described in detail in the first aspect, and it will be repeated here. The connection between the base and the optical fiber scanner is shown in FIGS. 2A-3C. As shown in FIGS. 2A-3C, a surface of the base carrying the optical fiber scanner may be a flat surface or a curved surface. Of course, the surface may also be set to other shapes according to requirements of actual situations so as to meet the requirements of actual situations, and this is not limited here.

In the specific implementation process, when a plurality of optical fiber scanners is provided, the plurality of optical fiber scanners may be arranged in a j*k array, j and k being positive integers.

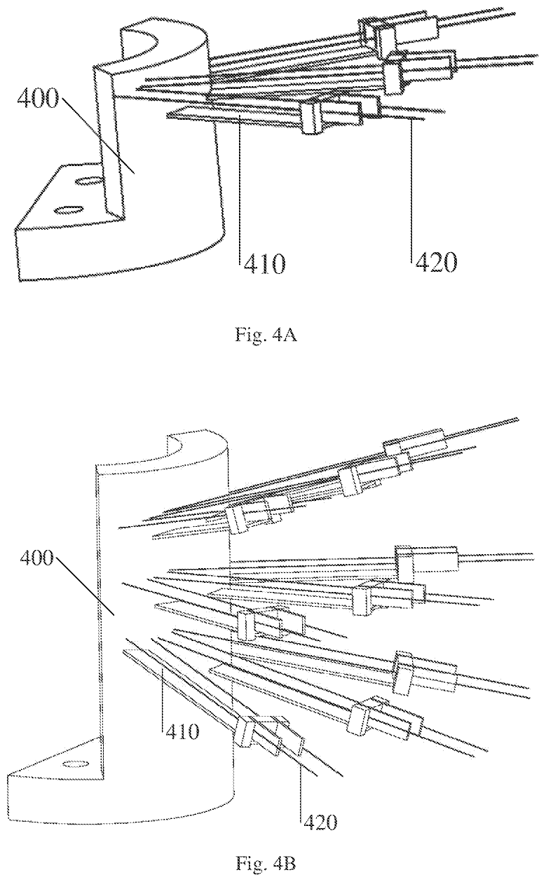

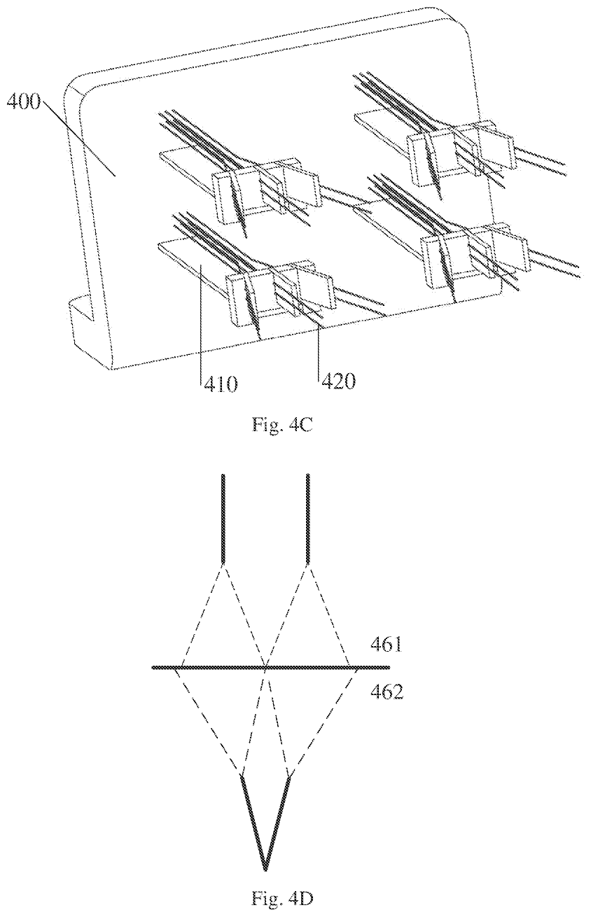

In FIGS. 4A-4C described below, a base 400 is used for carrying optical fiber scanners 410, and the optical fiber scanners 410 each are provided with optical fibers 420. It should be noted that the optical fibers 420 are not all labeled.

Referring to FIGS. 4A and 4B, FIGS. 4A and 4B are schematic diagrams each showing arrangement of a plurality of optical fiber scanners in an optical fiber scanning device with a base having a curved surface, according to an embodiment of the present disclosure. As shown in FIG. 4A, three optical fiber scanners are arranged in a 1*3 array, each optical fiber scanner includes two fast-axis driving units, and the optical fiber scanners are arranged radially. As shown in FIG. 4B, nine optical fiber scanners are arranged in a 3*3 array, three rows of optical fiber scanners are arranged radially, and optical fiber scanners in each row are arranged radially. Of course, in practical applications, an angle and distance between the optical fiber scanners may be set according to actual situations so as to meet requirements of actual situations, and this is not limited here.

Referring to FIG. 4C, FIG. 4C is a schematic diagram showing arrangement of a plurality of optical fiber scanners in an optical fiber scanning device with a base having a flat surface, according to an embodiment of the present disclosure. As shown in FIG. 4C, four optical fiber scanners are arranged in a 2*2 array, each optical fiber scanner includes three fast-axis driving units, two rows of optical fiber scanners are arranged in parallel, and optical fiber scanners in each row are also arranged in parallel. Of course, in practical applications, an angle and distance between the optical fiber scanners may be set according to actual situations so as to meet requirements of actual situations, and this is not limited here.

Referring to FIG. 4D, FIG. 4D is diagram of a comparison between two optical fiber scanners arranged in parallel and two optical fiber scanners arranged radially, wherein dashed lines 461 show a laser scanning range of the optical fiber scanners arranged in parallel, and dashed lines 462 show a laser scanning range of the optical fiber scanners arranged radially. It can be clearly seen from FIG. 4D that when two optical fiber scanners are arranged radially, all the beams projecting screens are emitted approximately at a cone angle, and the laser scanning range 462 of the optical fiber scanners arranged radially is significantly larger than the laser scanning range 461 of the optical fiber scanners arranged in parallel. In this way, a larger projection screen with a smaller light emission size is achieved, and a smaller light emission size is conducive to the miniaturization of a device and more convenient for users to carry and use.

It should be noted that, in the present disclosure, a plurality of optical fiber scanners is arranged radially, which means that a distance between two ends of at least two optical fiber scanners on the base is smaller than a distance between two ends of the two optical fiber scanners away from the base. The technical solution in which a distance between two ends of any two optical fiber scanners is smaller than a distance between two ends of said two optical fiber scanners away from the base, as introduced in this embodiment, is merely an example, but cannot be used for limiting the present disclosure.

It can be seen that, in an optical fiber scanning device, one slow-axis driving unit is connected to N fast-axis driving units through a connector, that is, one slow-axis driving unit can drive N fast-axis driving units simultaneously. In this way, the N fast-axis driving units can move synchronously in the vibration direction of the slow-axis driving unit, thereby achieving the technical effect of outputting high quality images. In addition, this can not only realize large-size and high-resolution display by stitching N images of the N fast-axis driving units, while ensuring synchronous display without delay between the images emitted by the respective fast-axis driving units, but also helps to reduce the vibration frequency of the slow-axis driving unit so that the slow-axis driving unit with a relatively small size can achieve a relatively large swing, and the driving method is simple, being conducive to the miniaturization of optical fiber scanners and optical fiber scanning projection apparatuses.

Based on the same inventive concept, a third aspect of the embodiments of the present disclosure further provides an optical fiber scanning projection apparatus, including the optical fiber scanning device described in the second aspect and a plurality of laser light sources. Optical fibers in the optical fiber scanning device are in one-to-one correspondence with the laser light sources, that is, laser light emitted by each optical fiber is provided by an independent laser light source.

In the specific implementation process, lasers may be solid lasers, gas lasers or optical fiber lasers. Solid lasers are lasers that use solid laser materials as working materials to generate laser light. Gas lasers are devices that use gases as working materials to generate laser light. Optical fiber lasers are lasers that use rare-earth-doped glass optical fibers as gain media. Of course, through the introduction of this embodiment, those skilled in the art can also use other suitable materials as working materials to generate laser light according to actual situations so as to meet requirements of actual situations, and this is not limited here.

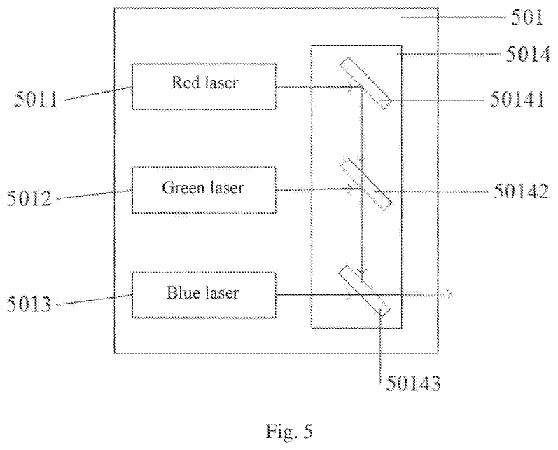

In the specific implementation process, in order to enable laser light sources to emit laser light of various colors, a laser provided by an embodiment of the present disclosure includes a red laser, a green laser, a blue laser, and a light combining unit. Referring to FIG. 5, FIG. 5 is a schematic diagram showing a structure of a laser provided by an embodiment of the present disclosure, wherein arrows indicate propagation directions of laser light. As shown in FIG. 5, a laser 501 may specifically include a red laser 5011, a green laser 5012, a blue laser 5013, and a light combining unit 5014. The light combining unit 5014 is used for combining light rays emitted from the red laser 5011, the green laser 5012 and the blue laser 5013, respectively. With continued reference to FIG. 5, as shown in FIG. 5, the red laser 5011 may specifically be a red laser light source, the green laser 5012 may specifically be a green laser light source, and the blue laser 5013 may specifically be a blue laser light source; this is not limited here. In this embodiment, the light combining unit 5014 includes a red light combining unit 50141 provided at an emission end of the red laser 5011, a green light combining unit 50142 provided at an emission end of the green laser 5012, and a blue light combining unit 50143 provided at an emission end of the blue laser 5013. As shown in FIG. 5, in this embodiment, the red light combining unit 50141 is specifically a color filter that reflects red light and that is provided at the emission end of the red laser 5011; the green light combining unit 50142 is specifically a color filter that transmits red light and reflects green light and that is provided at the emission end of the green laser 5012; and the blue light combining unit 50143 is specifically a color filter that reflects red and green light and transmits blue light and that is provided at the emission end of the blue laser 5013. In this way, the light rays emitted by the red laser 5011, the green laser 5012, or the blue laser 5013 can be combined by means of the color filter that reflects red light, the color filter that transmits red light and reflects green light, and the color filter that reflects red and green light and transmits blue light. In other embodiments, according to the difference in optical path design between the red laser 5011, the green laser 5012 and the blue laser 5013, the light reflection and light transmission characteristics of the respective light combining units in the light combining unit 5014 may be correspondingly different, and this is not limited here.

It can be seen that in an optical fiber scanning projection apparatus, one slow-axis driving unit is connected to N fast-axis driving units by means of a connector, that is, one slow-axis driving unit can drive N fast-axis driving units simultaneously. In this way, the N fast-axis driving units can move synchronously in the vibration direction of the slow-axis driving unit, thereby achieving the technical effect of outputting high quality images. In addition, this can not only realize large-size and high-resolution display by stitching N images of the N fast-axis driving units, while ensuring synchronous display without delay between the images emitted by the respective fast-axis driving units, but also helps to reduce the vibration frequency of the slow-axis driving unit so that the slow-axis driving unit with a relatively small size can achieve a relatively large scan range, and the driving method is simple, being conducive to the miniaturization of optical fiber scanners and optical fiber scanning projection apparatuses.

It should be noted that the above embodiments illustrate the present disclosure rather than limit the present disclosure, and those skilled in the art can design alternative embodiments without departing from the scope of the appended claims. In the claims, any reference signs placed in parentheses should not be constructed as limitation to the claims. The word “comprising” or “including” does not exclude the presence of elements or steps not listed in the claims. The word “a” or “an” preceding an element does not exclude the presence of a plurality of such elements. The present disclosure can be implemented by means of hardware comprising several different elements and by means of a suitably programmed computer. In unit claims enumerating several devices, several of these devices may be embodied in the same hardware item. The use of the words first, second, and third does not indicate any order, and these words can be interpreted as names.

One or more technical solutions in the embodiments of the present disclosure have at least the following technical effects or advantages.

A slow-axis driving unit is connected to N fast-axis driving units by means of a connector, that is, a slow-axis driving unit can drive N fast-axis driving units simultaneously. In this way, the N fast-axis driving units can move synchronously in the vibration direction of the slow-axis driving unit, thereby achieving the technical effect of outputting high quality images. In addition, this can not only realize large-size and high-resolution display by stitching N images of the N fast-axis driving units, while ensuring synchronous display without delay between the images emitted by the respective fast-axis driving units, but also helps to reduce the vibration frequency of the slow-axis driving unit so that the slow-axis driving unit with a relatively small size can achieve a relatively large swing, and the driving method is simple, being conducive to the miniaturization of optical fiber scanners, thereby expanding application scenarios of optical fiber scanners.

All features, or all methods or steps in a process disclosed in the present disclosure, except for mutually exclusive features and/or steps, can be combined in any manner.

Any feature disclosed in this description (including any appended claims, abstract and drawings), unless specifically stated, can be replaced by other equivalent features or alternative features with similar purposes. That is, unless otherwise stated, each feature is just an example of a series of equivalent or similar features.

The present disclosure is not limited to the foregoing specific embodiments. The present disclosure extends to any new features or any new combinations, as well as any new methods or steps of a process or any new combination disclosed in this description.

1. An optical fiber scanner, comprising a slow-axis driving unit, a connector, and N fast-axis driving units, wherein the connector has a slow-axis connecting structure for connecting the slow-axis driving unit, and N fast-axis connecting structures for connecting the N fast-axis driving units, and the slow-axis driving unit is connected to the N fast-axis driving units through the connector, N being an integer greater than or equal to 2.

2. The optical fiber scanner according to claim 1, wherein the fast-axis driving units each have a sheet-like shape; and the N fast-axis driving units are fixed to the connector in parallel, or the N fast-axis driving units are fixed radially to the connector.

3. The optical fiber scanner according to claim 1, wherein one or more optical fibers are fixed to each of the fast-axis driving units.

4. An optical fiber scanning device, comprising a base and at least one optical fiber scanner, which comprises a slow-axis driving unit, a connector, and N fast-axis driving units, wherein the connector has a slow-axis connecting structure for connecting the slow-axis driving unit, and N fast-axis connecting structures for connecting the N fast-axis driving units, and the slow-axis driving unit is connected to the N fast-axis driving units through the connector, N being an integer greater than or equal to 2.

5. The optical fiber scanning device according to claim 4, wherein a surface of the base that carries the optical fiber scanner is a flat surface or a curved surface.

6. The optical fiber scanning device according to claim 4, wherein provided is a plurality of optical fiber scanners, the plurality of optical fiber scanners forming a j*k array, j and k being positive integers.

7. The optical fiber scanning device according to claim 4, wherein provided is a plurality of optical fiber scanners, the plurality of optical fiber scanners being arranged radially.

8. An optical fiber scanning projection apparatus, comprising an optical fiber scanning device and a plurality of laser light sources,
wherein the optical fiber scanning device comprises a base and at least one optical fiber scanner, which comprises a slow-axis driving unit, a connector, and N fast-axis driving units, wherein the connector has a slow-axis connecting structure for connecting the slow-axis driving unit, and N fast-axis connecting structures for connecting the N fast-axis driving units, and the slow-axis driving unit is connected to the N fast-axis driving units through the connector, N being an integer greater than or equal to 2, and
wherein optical fibers in the optical fiber scanning device are in one-to-one correspondence with the laser light sources.

9. The optical fiber scanning projection apparatus according to claim 8, wherein the laser light sources are solid lasers, gas lasers or optical fiber lasers.

10. The optical fiber scanning projection apparatus according to claim 8, wherein the laser light sources include a red laser, a green laser, a blue laser, and a light combining unit.

11. The optical fiber scanning projection apparatus according to claim 8, wherein a surface of the base that carries the optical fiber scanner is a flat surface or a curved surface.

12. The optical fiber scanning projection apparatus according to claim 8, wherein provided is a plurality of optical fiber scanners, the plurality of optical fiber scanners forming a j*k array, j and k being positive integers.

13. The optical fiber scanning projection apparatus according to claim 8, wherein provided is a plurality of optical fiber scanners, the plurality of optical fiber scanners being arranged radially.

14. The optical fiber scanning device according to claim 4, wherein the fast-axis driving units each have a sheet-like shape; and the N fast-axis driving units are fixed to the connector in parallel, or the N fast-axis driving units are fixed radially to the connector.

15. The optical fiber scanning device according to claim 4, wherein one or more optical fibers are fixed to each of the fast-axis driving units.
